(19) United States
(12) Patent Application Publication
(10) Pub. No.: US 2015/0134402 A1
(43) Pub. Date: May 14, 2015

(54) SYSTEM AND METHOD FOR NETWORK-OBLIVIOUS COMMUNITY DETECTION

(71) Applicant: Yahoo! Inc., Sunnyvale, CA (US)

(72) Inventors: Nicola Barbieri, Barcelona (ES); Francesco Bonchi, Barcelona (ES); Giuseppe Manco, Rende (IT)

(73) Assignee: Yahoo! Inc., Sunnyvale, CA (US)

(21) Appl. No.: 14/076,551

(22) Filed: Nov. 11, 2013

(51) Int. Cl. G06Q 50/00; G06Q 30/02

(52) U.S. Cl. CPC G06Q 50/01; G06Q 30/0201
USPC 705/7.29

(57) ABSTRACT

Disclosed is a system and method for detecting online social communities through network-oblivious community detection techniques that involve modeling social contagion from a log of user activity. The log includes a dataset of tuples that record the instances when a user has adopted an item at a specific time. The disclose systems and methods then apply a stochastic framework that assumes that the adoptions of the item are governed by an underlying diffusion process over an unobserved social network, and that such diffusion model is based on community-level influence. By fitting the model parameters to the user activity log, community membership information and level of influence information can be derived for each user in each community.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure relates generally to network community detection, and more particularly, towards systems and methods for inferring a community structure of a social network within a network-oblivious setting.

### RELATED ART

In recent years, a multitude of social network capabilities and applications have come on-line connecting people both socially and professionally. Typically such social networking applications require a user to create a user identification (ID) and password and to identify their friends in order to create a profile. Additionally, many Web pages, such as news sites, blogs and so forth on the World Wide Web or Internet, describe the social activities of people and other entities; however, such information is not listed on or utilized by social networking application sites.

### SUMMARY

Although many social networking applications exist, there are not very many ways that the social connections or relationships between people and other entities that can readily be determined besides social networking graph mining. However, such techniques lack information associated with social connections of a user that can be used effectively for promoting products or for making interactions with the user personalized to the user. That is, conventional functionality lacks the resources or the expertise needed to build a system that can collect the necessary information required to capture the complete social aspects of a user.

The present disclosure describes systems and methods for detecting communities within an online social network when the social graph is not available. That is, the present disclosure directly detects communities of users in a network-oblivious setting, without attempting to reconstruct the network. The present disclosure, according to some embodiments, detects communities by analyzing a user activity log. Such analysis is based upon information analysis that implements assumptions forming a framework that 1) information can spread only by exploiting social connections among users, and 2) that the network has a community structure, where communities are densely connected internally, and loosely connected with external communities. Based on these assumptions, implementations of social contagion analysis, which is driven by social influence among users, can act locally, inside each community. Accordingly, such implementations can be utilized to detect communities across multiple networks, as the framework applied herein is network-oblivious. Therefore, the systems and methods discussed herein involve modeling social influence at a community level. User activity can be modeled, among other indicia, in terms of its community membership and influence levels of other users.

In accordance with one or more embodiments, a method is disclosed which includes receiving, at a computing device, a log of user activity for a plurality of users, said activity log comprising activity information for each of said plurality of users; determining, via the computing device, an unobserved social network of users, said determination comprising parsing the log of user activity and identifying users from said plurality that share connections with each other based on said activity information in the log; determining, via the computing device, a community within the unobserved social network of users, said community associated with a common activity identifiable from said log of user activity; determining, via the computing device, user membership within said community based on said activity information in said log of user activity, said user membership comprising a cluster of users sharing said common activity; determining, via the computing device, a level of influence for each user in said cluster, said level of influence comprising a measure of likelihood that each user's activity has an influence on another user's activity in said cluster, said measure of likelihood based on said activity information for each user in said cluster; and determining, via the computing device, a user from said cluster having a highest level of influence.

According to some embodiments, the method also includes that the determination of the unobserved social network is based upon an application of an Expectation Maximization (EM) algorithm on said log of user activity. According to some embodiments, the method also includes fitting model parameters of a diffusion model to portions of the log of user activity that are associated with the users in the unobserved social network, said model parameter fitting effectuating the modeling of social contagion of said plurality of users.

In accordance with one or more embodiments, a non-transitory computer-readable storage medium is provided, the computer-readable storage medium tangibly storing thereon, or having tangibly encoded thereon, computer readable instructions that when executed cause at least one processor to perform a method for inferring a community structure within a social network within a network-oblivious setting by mining a dataset of user activity. As discussed herein, the present disclosure implements embodiments involving methods and systems for detecting communities by modeling temporal dynamics, such as, but not limited to, a log of time-stamped user activity.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts is a schematic diagram illustrating a client device in accordance with some embodiments of the present disclosure;

FIG. 3 is a schematic block diagram illustrating components of a system in accordance with embodiments of the present disclosure;

FIG. 4 is a flowchart illustrating steps performed in accordance with some embodiments of the present disclosure; and

FIG. 5 is a block diagram illustrating architecture of a hardware device in accordance with one or more embodiments of the present disclosure.

### DESCRIPTION OF EMBODIMENTS

The present disclosure will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines. Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook®, LinkedIn®, Twitter®, Flickr®, or Google+®, Instagram™, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

The principles described herein may be embodied in many different forms. By way of introduction, detecting close-knit communities of like-minded people in on-line social networks is an important mining task with a wide array of applications. Knowing groups of users with similar interests allows the development of more personalized user experiences, and thus better web and mobile applications. For companies advertising and selling products through the internet, the community structure of a social network is of invaluable knowledge. For example, if a user responded positively to a certain campaign or product offer, companies may want to target other users in the same community. Such targeting can include, for example, (i) by homophily where there is an expectation that similar users are more likely to be interested in the same product than random users, and (ii) if more users in the same community adopt the same product, a word-of-mouth buzz or increased influence may be created or realized, thereby triggering more adoptions of the campaign or product in the same community.

Currently, community detection methods and implementations are limited to simple data analysis for social sciences. It is generally known that social network platforms are owned by third parties, such as Facebook® or Twitter®. Such platforms realize a propriety social graph as an asset where business owners can set up a company page and create display ads or promoted posts to reach users, however, such companies are not allowed to reconstruct the social graph, as the information housed on such social platforms are kept secret for a commercially competitive advantage. In an example, Twitter® sells its Firehose™, which is a stream of tweets (ranging from half a billion per day). Such sale of data occurs regardless the business partnership; however, the social graph is not disclosed, and in some instances, reconstruction of the social graph is explicitly forbidden by contract.

Thus, the present disclosure addresses shortcomings in the art by, inter alia, inferring the community structure when the social graph is not available. In fact, conventional approaches based on reconstruction of whole networks are unsuitable in cases of large datasets. Thus, the present disclosure provides systems and methods for scaling user activity data by providing increasingly accurate and effective results for retrieved communities. Further, the present disclosure involves analyzing alternative dynamics and available data capable of being exploited, as discussed in more detail below. For example, a company or entity advertising or developing applications over an on-line social network owns a log of user activity that it produces. In general, such activity log, referred to herein as “log D”, can be viewed as a set of tuples (u, i, t) which records the timestamp t at which the user u “acted on” or “adopted” the item i. By way of non-limiting examples, user u bought song i; user u clicked on ad i; user u rated movie i; user u liked photo i, and the like.

According to some embodiments, one basis for the disclosed systems and method involves exploiting social contagion to detect communities by analyzing, exclusively, the activity log D. “Social contagion”, for purposes of this disclosure, should be understood to refer to the spread of new practices, beliefs, technologies and products through a population of users (e.g., people), which is driven by social influence. Such social influence can include, but is not limited to, person-to-person recommendations, telecommunications services, information cascades driven by social media platforms, and the like. For example, the social contagion, driven by social influence, can be exploited for viral marketing applications. Thus, social contagion, and its applications discussed herein, is intrinsically connected to the community structure of a network. That is, individuals tend to adopt the behavior of their social peers. Therefore, as discussed in more detail below, social contagion occurs first locally, within close knit communities, and spreads virally only when it is able to cross boundaries of these densely connected clusters of individuals (e.g., users). That is, social contagion is predicated upon observed and unobserved social networks having a modular structure.

According to embodiments of the present disclosure, such social contagion exploitations are formed upon basic assumptions that (i) information can spread only by exploiting the social connections among users, and that (ii) the network has a community structure, where communities are densely connected internally, and loosely connected with other communities. Thus, as a consequence of these two assumptions, social contagion acts mainly locally, inside each community. Thus, if a group of users acting on item i in a short time frame is observed, detected or determined, and such actions are occurring on various different items, then the disclosed systems and methods can infer that these users are connected in (or within) some social network, and that the users are not only communicating, but also are able to influence each other.

It should be understood by those of skill in the art that the unobserved social network need not necessarily be unique and/or clearly defined, as users can communicate through different media. That is, according to embodiments of the present disclosure, communications can occur through, but not limited to, e-mail, telephone, SMS, MMS, and the like, in addition to social communications facilitated through platforms including, but not limited to, Facebook®, Twitter®, Skype®, iMessage®, Yahoo!® Messenger, WhatsApp® and the like. In addition, according to some embodiments, such communications can also occur within the real world between people (e.g., while people are having dinner together at a restaurant). The uniqueness, type of network (virtual or in reality) and/or definition of network boundaries and parameters does not impede the implications of the present disclosure, as observations of the adoptions (or activations) and their timing(s) are network-oblivious, in that the applied framework discussed herein addresses detecting communities over multiple networks and across multiple platforms.

As discussed in more detail below, a general framework of the disclosed systems and methods can be instantiated through the use of diffusion models. As discussed below, the present disclosure utilizes two models: an extension of the classic (discrete time) Independent Cascade model and fine-grained modeling. Independent Cascade modeling should be understood to be based upon the assumption that each user exerts the same degree of influence over a whole community (for which the user is involved or connected to through some degree of separation). Fine-grained modeling involves the applications of directly focusing on activation times, which involves assuming that each user induces a fixed delay on the activation times of social peers within the same community.

Thus, the present disclosure not only detects communities by exploiting social influence information (e.g., evidence), but the systems and methods discussed herein, as a by-product of such social influence evidence, defines the level of influence of each user in each community. This enables the identification of “key” users within each community (i.e., leaders who are most likely to influence the rest of the community to adopt a certain item). Thus, for example, such “key” users would be the ideal users to target in a viral marketing campaign.

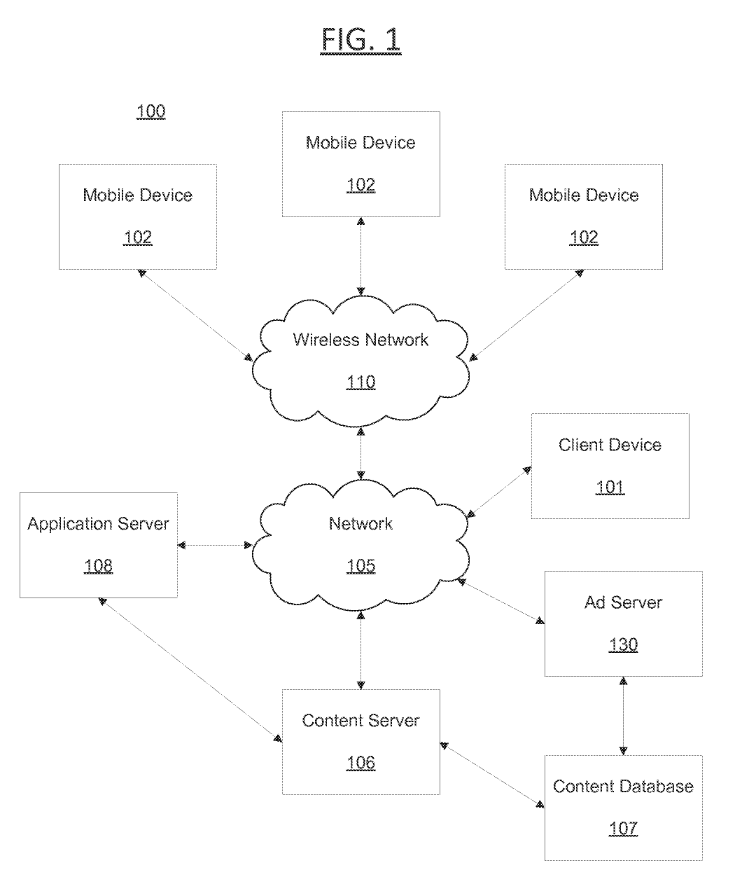

Certain embodiments will now be described in greater detail with reference to the figures. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)—network 105, wireless network 110, mobile devices (client devices) 102-104 and client device 101. FIG. 1 additionally includes a variety of servers, such as content server 106, application (or “App”) server 108, and advertising (“ad”) server 130.

One embodiment of mobile devices 102-103 is described in more detail below. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include multi-touch and portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 102-104 also may include at least one client application that is configured to receive content from another computing device. The client application may include a capability to provide and receive textual content, graphical content, audio content, and the like. The client application may further provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier.

In some embodiments, mobile devices 102-104 may also communicate with non-mobile client devices, such as client device 101, or the like. In one embodiment, such communications may include sending and/or receiving messages, share photographs, audio clips, video clips, or any of a variety of other forms of communications. Client device 101 may include virtually any computing device capable of communicating over a network to send and receive information. The set of such devices may include devices that typically connect using a wired or wireless communications medium such as personal computers, multiprocessor systems, microprocessor-based or programmable consumer electronics, network PCs, or the like. Thus, client device 101 may also have differing capabilities for displaying navigable views of information.

Client devices 101-104 computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly. Wireless network 110 may further employ a plurality of access technologies including 2nd (2G), 3rd (3G), and/or 4th (4G) generation radio access for cellular systems, WLAN, Wireless Router (WR) mesh, and the like. Access technologies such as 2G, 3G, 4G and future access networks may enable wide area coverage for mobile devices, such as mobile devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile device s 102-104 and another computing device, network, and the like.

Network 105 is configured to couple content server 106, application server 108, or the like, with other computing devices, including, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2. T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between content server 106, application server 108, client device 101, and/or other computing devices.

Within the communications networks utilized or understood to be applicable to the present disclosure, such networks will employ various protocols that are used for communication over the network. Signal packets communicated via a network, such as a network of participating digital communication networks, may be compatible with or compliant with one or more protocols. Signaling formats or protocols employed may include, for example, TCP/IP, UDP, DECnet, NetBEUI, IPX, APPLETALK™, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

According to some embodiments, the present disclosure may also be utilized within or in conjunction with a social networking site. A social network refers generally to an electronic or digital, person to person, or combination thereof, network of individuals, such as acquaintances, friends, family, colleagues, or co-workers, coupled via a communications network or via a variety of sub-networks. Potentially, additional relationships may subsequently be formed as a result of social interaction via the communications network or sub-networks. In some embodiments, multi-modal communications may occur between members of the social network. Individuals within one or more social networks may interact or communication with other members of a social network via a variety of devices. Multi-modal communication technologies refers to a set of technologies that permit interoperable communication across multiple devices or platforms, such as cell phones, smart phones, tablet computing devices, personal computers, televisions, set-top boxes, SMS/MMS, email, instant messenger clients, forums, social networking sites, or the like.

In some embodiments, the disclosed networks 110 and/or 105 may be cloud based and/or may comprise a content distribution network(s). A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. A CDN may also enable an entity to operate or manage another's site infrastructure, in whole or in part.

The content server 106 may include a device that includes a configuration to provide content via a network to another device. A content server 106 may, for example, host a site or service, such as an email platform, social networking site music site/platform (e.g., Yahoo!® Music), a movie site or platform (e.g., Yahoo!® Movies) or any other type of content hosted, retrievable, downloadable or accessible via a web page or service, or a personal user site (such as a blog, vlog, online dating site, and the like). Indeed, a content server 106 may also host a variety of sites providing any range of content, including, but not limited to, music sites, movie sites, streaming content, business sites, educational sites, dictionary sites, encyclopedia sites, wikis, financial sites, government sites, and the like. In some embodiments, the content server 106 may also provide advertising or marketing content. Devices that may operate as content server 106 include personal computers desktop computers, multiprocessor systems, microprocessor-based or programmable consumer electronics, network PCs, servers, and the like.

Content server 106 can further provide a variety of services that include, but are not limited to, email services, photo services, web services, third-party services, audio services, video services, email services, instant messaging (IM) services, SMS services, MMS services, FTP services, voice over IP (VOIP) services, or the like. Such services, for example the email services and email platform, can be provided via the content server 106. Examples of content may include images, text, audio, video, or the like, which may be processed in the form of physical signals, such as electrical signals, for example, or may be stored in memory, as physical states, for example.

An ad server 130 comprises a server that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with user. Such sponsored advertising includes monetization techniques including sponsored search advertising, non-sponsored search advertising, guaranteed and non-guaranteed delivery advertising, ad networks/exchanges, ad targeting, ad serving and ad analytics.

For example, a process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers. For web portals like Yahoo!®, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s). Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

Servers 106, 108 and 130 may be capable of sending or receiving signals, such as via a wired or wireless network, or may be capable of processing or storing signals, such as in memory as physical memory states. Devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally, a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

In an embodiment, users are able to access services provided by servers 106, 108 and/or 130. This may include in a non-limiting example, email servers, social networking services servers, SMS servers, IM servers, MMS servers, exchange servers, photo-sharing services servers, and travel services servers, via the network 105 using their various devices 101-104. In some embodiments, applications, such as a photo-sharing or viewing application (e.g., Flickr®, Instagram®, and the like), can be hosted by the application server 108. Thus, the application server 108 can store various types of applications and application related information including application data and user profile information. In another example, a content server 106 acting as an email server can host email applications; therefore, the content server 106 can store various types of applications and application related information including email application data and user profile information, which can be correlated with the application server 108. It should also be understood that content server 106 can also store various types of data related to the content and services provided by content server 106 in an associated content database 107, as discussed in more detail below. Embodiments exist where the network 105 is also coupled with/connected to a Trusted Search Server (TSS) which can be utilized to render content in accordance with the embodiments discussed herein.

Moreover, although FIG. 1 illustrates servers 106, 108 and 130 as single computing devices, respectively, the disclosure is not so limited. For example, one or more functions of servers 106, 108 and/or 130 may be distributed across one or more distinct computing devices. Moreover, in one embodiment, servers 106, 108 and/or 130 may be integrated into a single computing device, without departing from the scope of the present disclosure.

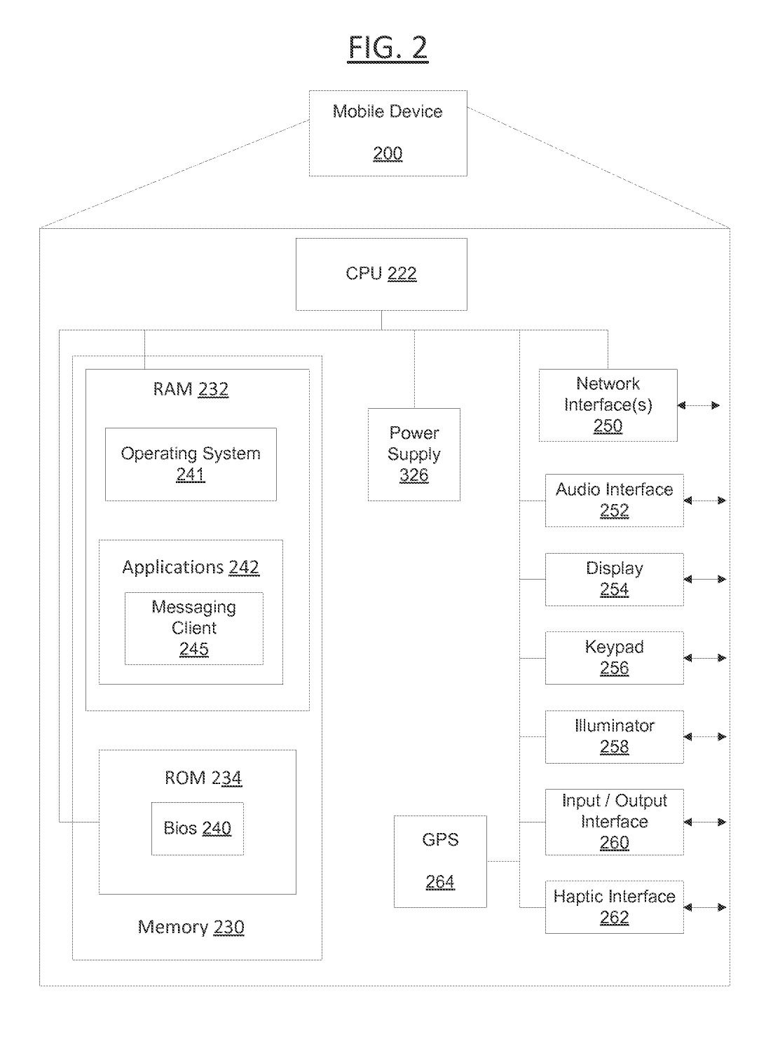

FIG. 2 is a schematic diagram illustrating a client device showing an example embodiment of a client device that may be used within the present disclosure. Client device 200 may include many more or less components than those shown in FIG. 2. However, the components shown are sufficient to disclose an illustrative embodiment for implementing the present disclosure. Client device 200 may represent, for example, client devices discussed above in relation to FIG. 1.

As shown in the figure, Client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to Client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling Client device 200 to one or more networks, and is constructed for use with one or more communication protocols and technologies including, but not limited to, global system for Client communication (GSM), code division multiple access (CDMA), time division multiple access (TDMA), user datagram protocol (UDP), transmission control protocol/Internet protocol (TCP/IP). SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when the Client device 200 receives a communication from another user.

Optional GPS transceiver 264 can determine the physical coordinates of Client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of Client device 200 on the surface of the Earth. It is understood that under different conditions, GPS transceiver 264 can determine a physical location within millimeters for Client device 200; and in other cases, the determined physical location may be less precise, such as within a meter or significantly greater distances. In one embodiment, however, Client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of Client device 200. The mass memory also stores an operating system 241 for controlling the operation of Client device 200. It will be appreciated that this component may include a general purpose operating system such as a version of UNIX, or LINUX™, or a specialized client communication operating system such as Windows Client™, or the Symbian® operating system. The operating system may include, or interface with a Java virtual machine module that enables control of hardware components and/or operating system operations via Java application programs.

Memory 230 further includes one or more data stores, which can be utilized by Client device 200 to store, among other things, applications 242 and/or other data. For example, data stores may be employed to store information that describes various capabilities of Client device 200. The information may then be provided to another device based on any of a variety of events, including being sent as part of a header during a communication, sent upon request, or the like. At least a portion of the capability information may also be stored on a disk drive or other storage medium (not shown) within Client device 200.

Applications 242 may include computer executable instructions which, when executed by Client device 200, transmit, receive, and/or otherwise process audio, video, images, and enable telecommunication with another user of another client device. Other examples of application programs include calendars, browsers, contact managers, task managers, transcoders, database programs, word processing programs, security applications, spreadsheet programs, games, search programs, and so forth. Applications 242 may further include messaging client 245 that is configured to send, to receive, and/or to otherwise process messages using SMS, MMS, IM, email, VOIP, and/or any of a variety of other messaging communication protocols. Although a single messaging client 245 is illustrated it should be clear that multiple messaging clients may be employed. For example, one messaging client may be configured to manage SMS messages, where another messaging client manages IM messages, and yet another messaging client is configured to manage serving advertisements, emails, or the like.

Having described the components of the general architecture employed within the disclosed systems and methods, the components' general operation with respect to the disclosed systems and methods will now be described.

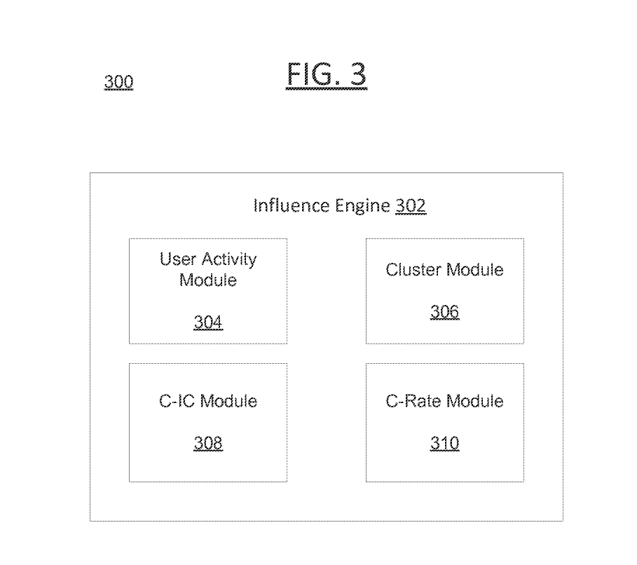

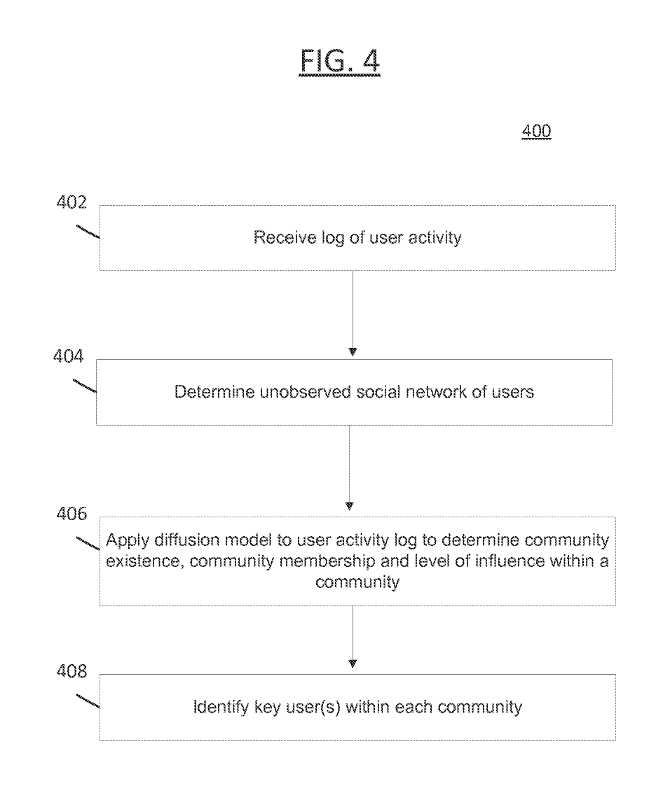

FIG. 3 is a block diagram illustrating the components of system 300 for performing the systems and methods discussed herein. FIG. 3 includes an influence engine 302. The influence engine 302 could be hosted by a web server, content provider, application service provider, advertisement server, a user's computing device, or any combination thereof. The influence engine 302 includes a user activity module 304, cluster module 306, Community-Level Independent Cascade (C-IC) module 308 and a Community Rate (C-Rate) module 310. It should be understood that the engine(s) and modules discussed herein are non-exhaustive, as additional or fewer engines and/or modules may be applicable to the embodiments of the systems and methods discussed. The operations, configurations and functionalities of the influence engine 302 and each module 304-310, and their role within embodiments of the present disclosure will be discussed with reference to FIG. 4, whereby the components of system 300 are implemented to perform the steps and processes discussed below.

Turning to FIG. 4, process 400 is now described with specific reference to components of system 300. FIG. 4 is a process 400 diagram illustrating steps performed in accordance with embodiments of the present disclosure.

As discussed above, the present disclosure provides systems and methods for network-oblivious community detection by exploiting user activity information, referenced as a user activity log (log D) for each user on the network. The systems and methods discussed herein are based upon a stochastic framework (or modeling) that utilizes user activities that are governed by an underlying diffusion process over a social network. In some embodiments, the social network is an unobserved social network (i.e., undefined but associated with a set of users v), as discussed in more detail below. Communities within such networks can be defined by clusters of nodes that exhibit high internal and low external link density. According to some embodiments, not to be construed as limiting, communities can be a partitioning of the set of users v, in that the communities can be disjoint. However, it should be understood that, due to the stochastic framework, a level of membership within each community is defined for each user of v. Therefore, an assignment of multiple overlapping communities can be defined or determined.

As discussed above, the stochastic framework for modeling user memberships in communities is defined based on community-level social influence. The stochastic framework assumes that user activities are governed by an underlying diffusion process over the unobserved social network. Thus, by fitting model parameters to the user activity log within the unobserved social network, as discussed below, community membership and the level of influence of each user in each community can be determined. This enables the identification of a user or users in each community, or across multiple communities, that are most likely to influence the rest of the community to adopt certain activities or items.

According to some embodiments, Process 400 is based upon the assumption, among others, that an unobserved social network naturally shapes the process of information diffusion. Indeed, in some embodiments, the existence of an unobserved social network includes such network having a modular structure, where communities exist and are densely connected internally, and loosely connected with other communities. Process 400 begins in Step 402, where an input of a log of past user activity D is received. That is, the influence engine 300 receives log D for each user. In some embodiments, log D can be a single log comprising activity information for all users on a network. This log activity is requested and received, or retrieved, and processed by the user activity module 304. The activity information comprised in log D can include, but is not limited to, a user's behavior or activity on-line, including but not limited to activities on social network pages, web sites, posts, feedback, messages, emails, a click-through on a displayed advertisement, purchases of items, and the like, in addition to real world activities traceable from “check-ins” on detected devices via Global Positioning Information (GPS) to accountings of a user's location and real-world activities. The behavior or activities identified in log D can be based on past, present and/or future (expected or inferred) user activity. Additionally, such activity information can be updated in near real-time, in that upon the activity being detected, the log D for a specific user can reflect the type of activity, which updates the information provided in the log D for the user.

According to embodiments of the present disclosure, as discussed above, the log of user activity D (i.e., log D) is defined as a relation (User; Item; Time) where each tuple (u, i, t) indicates that the user (or node) u adopted (or acted on) item i at the time t. As discussed above, “adopting” an item can include, but is not limited to, a user's behavior or activity on-line, including but not limited to activities occurring over a network and/or in the real-world. User activities described in log D, as discussed above, are governed by the underlying stochastic diffusion process over the unobserved social network. In some embodiments, the diffusion model applied is based on community-level influence. Thus, as discussed in more detail below, given only the user activity log D, the present disclosure effectuates detection of communities (Step 406) in a determined unobserved social network (Step 404). As discussed above, such communities include a set of nodes corresponding to the set of users, or in other words, communities comprise clusters of nodes of a social network that exhibit high internal and low external link density.

In Step 404, an unobserved social network is determined based upon the received log D. The unobserved network, which is comprised of to be determined communities (in Step 406 as discussed below), is determined based upon the activity information identifiable from log D. Such determination is effectuated by the cluster module 306, where the information in log D is parsed to identify connections of users based on each user's identified activity (or adoptions or activations). User memberships within the network can be determined based upon a devised expectation maximization (EM) learning algorithm model applied to the information in log D. That is, the information comprised within the log D is run through the EM model, and as a result, a determination is made regarding the structure and membership of the unobserved social network, thereby allowing the automatic detection of the users in a network, as well as the total number of communities within a network (or across multiple networks). The determined (or detected) structure of the unobserved network can include the type of network, and capabilities and parameters of such network, while the membership includes the users populated within the network, which is based on activities derived from log D. For example, from log D for user A, information shows that user A interacted with user B over email and user C on Facebook®. Therefore, while users A, B and C may not be within a defined, classic network, according to the application of the EM model, an unobserved network of user's A, B and C can be identified, where the make-up of the network bounds across social platforms and messaging platforms (e.g., email). It should be understood by those of skill in the art that any known or to be known learning model may be applied to the information in the log D to model such information, as discussed herein.

According to some embodiments, the EM learning model embodies an annihilation mechanism (or any other known or to be known mechanism). Therefore, a network and/or community not supported by a sufficient number of users are suppressed—failing to satisfy a membership threshold. An advantage of the application of the EM learning model, and like models, is the robustness to random initialization. That is, by starting with an arbitrarily large number of information derived from log D, Process 400 can avoid the pitfalls of local maxima, as the whole parameter space of users' networks and the communities therewith are to be covered.

In Step 406, model parameters of a diffusion model are applied (or fit) to the user activity log D of each user within the determined unobserved social network in order to identify communities within the unobserved social network and user influence levels within each community. That is, Step 406 provides the determination of 1) communities in the unobserved social network, 2) user membership in such communities, and 3) each user's level of influence within each community for which they belong. By fitting the model parameters of diffusion models discussed below to the user activity log D, the disclosed systems and methods can determine user community membership and influence levels. According to some embodiments, the general framework applied in Process 400 can be instantiated via known or to be known community-level influence diffusion models.

According to some embodiments, fitting model parameters of diffusion models in Step 406 effectuates the modeling of social contagion respective user activity within the unobserved social network (and communities comprised within such network). As discussed above, social contagion is driven by social influence which details the spread of new practices, beliefs, technologies and products through a population of users. According to embodiments of the present disclosure, social contagion exploitations are formed upon basic assumptions that (i) information can spread only by exploiting the social connections among users, and that (ii) the network has a community structure, where communities are densely connected internally, and loosely connected with other communities. Thus, as a consequence of these two assumptions, social contagion acts mainly locally, inside each community. Thus, if a group of users acting on item i in a short time frame is observed, detected or determined, and such actions are occurring on various different items, then the disclosed systems and methods can infer that these users are connected in (or within) some social network, and that the users are not only communicating, but also are able to influence each other.

According to some embodiments, applicable models for the fitting occurring in Step 406 include, but are not limited to, 1) a Community-Independent Cascade (C-IC) model (via module 308), which draws from, or is an extension of the classic (discrete time) Independent Cascade (IC) model, and 2) fine-grain modeling (via module 310). Some embodiments of the present disclosure's application of diffusion models is centered on fine-grain modeling, as discussed below. In some embodiments C-IC modeling is applicable, and such modeling is discussed to provide a complete description of the presently disclosed systems and methods.

Fine-grain modeling and C-IC modeling are dependent upon a probability model P(a) for given actions (a) derived from log D. Such actions (a) are derived from log D for each user, as discussed above, which can be referenced as a=(u, i, t). C-IC modeling is based upon a probability that user u adopts item i as a result of a bernoullian process on item i. For example: P(a)=P(i|u,t), and time proceeds in discrete steps. Fine-grain modeling does not consider whether user u adopts item i; such modeling is based upon when the adoption occurs. For example, P(a)=P(t|i,u). According to some embodiments, each type of modeling is applicable to the systems and methods of the present disclosure, and will be expanded upon individually below. Thus. Step 406 focuses on determining a user u (or cluster of users) from an overall set of users that are more likely to influence the largest number of users in the unobserved social network. According to some embodiments, this can be based upon an underlying propagation model applied in conjunction with the diffusion model, where given a social network (i.e., the unobserved network from Step 404), each association (or arc) between user u from an overall set of users v: (u, v) is associated with a weight (or probability) p_{u,v} representing the strength of influence that user u exerts over set of users v. Thus, based on each users adoption of item i at time t, respective other user's adoption of item i, at time tᵢ (where tᵢ may or may not be equal to t), Process 400 can determine 1) communities in the unobserved social network, 2) user membership in such communities, and 3) each user's level of influence within each community for which they belong.

For example, users A, B, C and D have the following tuples in each user's respective activity log D: user A adopted item N at time T1 (A, N, T1); user B adopted item N at time T2 (B, N, T2); user C adopted item X at time T3 (C, X, T3); user D adopted item N at time T6 (D, N, T6). Based on the Process 400 discussed herein, which is a stochastic framework based on community-level social influence between users A, B, C and D, each user's activity is modeled in terms of its community membership and influence levels of other users. That is, based on similarities of item adoption, and occurrences of time respective other user adoption, a community can be modeled, and the influencing user leading other users to adopt the same (or similar item) can be determined or identified. For example, the adoption of item N by user A depends on the level of adoption of the item N in the community K; or in other words, by the influence exerted by user A over users B, C and D and whether users B, C and D have adopted item N, and when (e.g., timing or time delay) such adoption occurred.

Thus, from the above example, user A adopted item N first in time (T1). Following user A, users B and D also adopted item N at times T2 and T6. User C adopted a different item X. Therefore, a community can be determined based on the adoption of a similar item, and such community can be determined to include only users A, B and D, as user C did not adopt the same item. Further, since user A adopted item N prior to users B and D, user A would be determined to carry the highest level of influence in the community (thereby having the highest measure of influence). In some embodiments, since user B adopted item N prior to user D, user B could be determined to have a level of influence measure greater than user D. Thus, the level of influence could be determined as follows, with user A having the highest, then user B, followed by user D having the lowest level of influence. Also, as discussed below in more detail, user A would have a higher influence on user B than on user D, as the time delay from user A adoption of item N was shorter for user B than user D (T1->T2; T1->T6, respectively). As such, from the above example, Step 406 provides the determination of 1) communities in the unobserved social network, 2) user membership in such communities, and 3) each user's level of influence within each community for which they belong.

C-IC Modeling:

Turning first to modeling predicated upon time proceeding in discrete steps, C-IC modeling is based upon a bernoullian model for users' adoptions. It should be understood that other applications of known or to be known discrete probability distributions are also applicable to the C-IC model. Generally, C-IC modeling describes how adoptions spread across a network by modeling information propagation and community structure. In C-IC, a user's tendency to become active increases monotonically as more of the user's social peers becomes active. Adapted to a network-oblivious environment, a user's tendency to become active is dependent upon the influence exerted within the community of membership.

The C-IC model draws from the known IC model, and models the underlying assumption that each user exerts the same degree of influence over members of each community. In C-IC modeling, time unfolds in discrete timestamps. Specifically, C-IC modeling generalizes the IC model by modeling influence at the community level. While IC parameters are in the form of p_{u,v}, which is the strength of the influence of the user u on the set of users v, in C-IC, the focus is upon an estimate of p^{k}_u, which is the strength of user u's influence on members of the community k. C-IC is predicated upon the motivation that each user exhibits the same strength of influence on members of the same community.

As in IC, when a user u becomes active, at time t, it is considered contagious and has a single chance of influencing each other user (which may be inactive), independent of whether there is a history of activity of the other user(s) or influence on the other user(s). The C-IC model, building upon IC modeling, specifies pairwise influence probabilities p_{u,v}, which expresses the likelihood of success for user u's attempt in activating his/her neighbor user (i.e., influencing the neighbor user to adopt user u's activity). User u's influence is presumed to encompass a “global” influence within a network, with such influence being of greater value for each community user u actually belongs to. Therefore, the C-IC model effectuates propagation of information locally, and the spread across other communities is due to the presence of users being influenced by user u being additionally coupled with other communities (or exhibiting an external influence).

According to embodiments of the present disclosure, the C-IC model implements the equation:

$$P ( 𝔻 \vert Z , Θ ) = {\prod }_{i , u , k} {[ 1 - {\prod }_{v ∈ {F}_{i , u}^{+}} ( 1 - {p}_{v}^{k} ) ]}^{{z}_{u , k}} \cdot {[ {\prod }_{v ∈ {F}_{i , u}^{-}} ( 1 - {p}_{v}^{k} ) ]}^{{z}_{u , k}}$$

From the above equation, Z is the matrix encoding user-to-community assignments: z_{u,k}=1, if the user u has been assigned to the community k. Otherwise, if the user has not been assigned to the community k: z_{u,k}=0. Thus, through the above equation, the C-IC model essentially determines the set of assignments Z that best fit the observed data identifiable from log D, thereby maximizing P(D|Z). Thus, the above equation can be parsed to show, for each pair of user adoptions: (u,i), there are two cases:

First Case: (u,i) \in D—user u has adopted i; and

Second Case: (u,i) \not \in D—user u has not adopted i.

In the first case, where user u has adopted i, there is a need to maximize the probability of adoption (of the item i). Therefore, the C-IC model maximizes the likelihood that at least one of the possible influencers (i.e., users in a community) triggered user u's adoption of item i (also referred to activation). If user u has not adopted, as in the second case, then the C-IC model maximizes the probability that all the influencers in the community have failed in activating user u (or influencing user u to adopt item i). The two brackets (i.e., first and second bracket) in the above equation, respectively, express this concept regarding the first and second case.

In both cases, the C-IC model considers (or accounts for) the current community assignment of user u, which effectively is the product over the communities k and the latent community assignment z_{u,k}. In this case, essentially just one component k is active: z_{u,k}=1. Regarding the first case discussed above: (u,i) \in D; at least one influencer in F⁺ has high influence in the community to which user u is assigned. The second case: (u,i) \not \in D is symmetrical; however, the C-IC model here models the fact that the influence of all possible influencers in F was low in the community user u is assigned.

Compounding on the above information and analysis, in an embodiment, the C-IC model further estimates the community assignments that maximize the likelihood P(D|Z). Thus, the C-IC model utilizes the EM algorithm, which leads to the optimization of the following objective function:

$${\sum }_{u} {\sum }_{k} {γ}_{u , k} ( log {π}_{k} + {\sum }_{i} {\sum }_{v ∈ {F}_{i , u}^{-}} log ( 1 - {p}_{v}^{k} ) + {\sum }_{i} {\sum }_{v ∈ {F}_{i , u}^{+}} {η}_{i , u , v , k} log {p}_{v}^{k} + ( 1 - {η}_{i , u , v , k} ) log ( 1 - {p}_{k}^{k} ) ) , \\ where \\ \backslash gamma\_ \{ u , k \} = P ( z\_ \{ u , k \} = 1.$$

In the above formula, there was the additional usage of the variable \eta{i,u,v,k}. This variable is the probability that when user u is assigned to be in community k, user v is influencer of user u's adoption, or in other words, user v is the responsible user for triggering user u's adoption on item i. This equation is optimized through the C-IC models application of the following steps, which in some embodiments, may be in alternative to each other:

$$Gamma\_ \{ u , k \} = P ( u \vert {Θ}_{k} ) = {\prod }_{.} {{P}_{+} ( i \vert u , {Θ}_{k} )}^{{Y}_{i , u}} \cdot {P}_{-} ( i \vert u , {Θ}_{k} ) , ;$$

$$and$$

$$\begin{matrix}{η}_{i , u , v , k} = P ( {w}_{i , u , v} = 1 \vert u , i , {z}_{u , k} = 1 , {θ}^{( t - 1 )} ) \\ = \frac{{p}_{v}^{k}}{1 - {\prod }_{w ∈ {F}_{i , u}^{+}} ( 1 - {p}_{w}^{k} )} .\end{matrix}$$

$${p}_{v}^{k} = \frac{{\sum }_{{〈 u , i 〉}_{v ∈ {F}_{i , u}^{+}}} {γ}_{u , k} \cdot {η}_{i , u , v , k}}{{S}_{v , k}^{+} + {S}_{v , k}^{-}} , \\ with$$

$${S}_{v , k}^{+} = {\sum }_{{〈 u , i 〉}_{v ∈ {F}_{i , u}^{+}}} {γ}_{u , k}$$

$$and$$

$${S}_{v , k}^{-} = {\sum }_{{〈 u , i 〉}_{v ∈ {F}_{i , u}^{-}}} {γ}_{u , k} .$$

Thus, through applications of the C-IC model and the equations discussed above, Process 400 can determine communities and community membership of users within the unobserved social network. Step 406. Additionally, the C-IC model also effectuates the determination of each user's influence within each community over other users. Step 406. By fitting the model parameters of the C-IC model to the user activity log D, the disclosed systems and methods can determine user community membership and influence levels, as discussed above.

Fine-Grain Modeling:

As discussed above, fine-grained modeling involves directly focusing on activity times derived from log D. As discussed above, log D comprises for each user a set of tuples (u, i, t) which records the timestamp t at which the user u “acted on” or “adopted” the item i. Thus, such fine-grained modeling exploits time to characterize an overall diffusion process. In other words, each user is associated with a level of membership and a level of influence in each community, as derived from log D for the user. The adoption of an item i by a user u depends on the level of adoption of the item in the community of u, or in other terms, by the influence exerted by the other members of the community on u for adopting i.

According to the present disclosure, an embodiment of fine-grain modeling is a Community Rate (C-Rate) propagation model. It should be understood that any other known, or to be known fine-grain modeling are applicable in a similar manner discussed herein. The C-Rate model is utilized to explicitly model the likelihood of time at which each user adopted each item. In some embodiments, the C-Rate model is used to model the likelihood that the considered adoption of an item did not happen within specified time range.

C-Rate modeling explicitly models temporal dynamics by combining social influence and survival analysis (i.e., analysis of time to events respective the probability that a user survives uninfected at least until a particular time t). In some embodiments, C-Rate modeling may additionally or alternatively employ hazard modeling, which models instantaneous infections. C-Rate modeling's underlying social influence model assumes that when a user adopts an item it is considered contagious. That is, adoption of an item by one user within a community influences other users in the community to do the same. This contagious consideration assumption effectuates an increased chance of triggering activation of inactive peers via social influence.

For example, the assumption is based on the expectation that if user A posts a link on his/her social page regarding product X, then other users in user A's community will also “adopt” product X (or at least be active respective product X, e.g., view product X). Thus, by exploiting survival analysis modeling, C-Rate modeling incorporates the assumption that there exists a dependency between adoption time of the influencer and others within the influencer's community. Furthermore, C-Rate modeling is based upon the governing principle to model time delay between activations on the same item of at least two social peers. Thus, as discussed in more detail below, through applications of C-Rate, the frequent observations that user u adopted items previously adopted by user v after a certain time delay leads to the determination that user v is the influencer for user u according to an estimated transmission delay (which is based upon the delay in adoption).

Further, the C-Rate model is characterized by additional underlying (and/or governing assumptions). The C-Rate model assumes that a user's influence is limited to the community he/she belongs to. That is, the user is likely to influence/be influenced by members of the same community, while the effect of the influence is marginal on members of a different community. The C-Rate model further is based upon the assumption that each user exhibits the same degree transmission rate α_{v,k} members of the same community. The probability contagion respective a cluster of users depends on the time delay between the information diffusion between users of a community: user A to user B within community k. Additionally, the probability contagion is also dependent upon user A's transmission rate on the community k user A belongs to. That is, the rate of adoption, or activation of item i within community k. The community transmission rate parameter α_{v,k} has a direct interpretation in terms of influence, in that high values of transmission rate cause short delays, and as a result denote a strong level of influence within a considered community. Thus, given an observation window from zero to time [0, T], C-Rate modeling models the likelihood of time at which each user in community k adopted each item within time T. This modeling is in terms of user memberships in the community and social influence, which are optimized to fit the input data, i.e., log D (from Step 402).

Based on the above, the C-Rate model builds and improves upon known survival model, the NetRate model. The basic premise behind the C-Rate model involves modeling the probability that user u adopt an item i at time t1 given that user v adopted item i at time t2, where t2<t1. This modeling involves employing a term which quantifies the transmission delay: f(t_u|t_v,α_{v,u}).

Thus, the core equations for implementing C-Rate are as follows:

$$P ( 𝔻 , W \vert Z , Θ ) = {\prod }_{〈 u , i 〉 ∉ 𝔻} {\prod }_{k} {\prod }_{v ∈ {C}_{i}} {S ( T \vert {t}_{v} ( i ) , {α}_{v , k} )}^{{z}_{u , k}} \cdot {\prod }_{〈 u , i 〉 ∈ 𝔻} {\prod }_{k} {\prod }_{v ∈ {C}_{i , {t}_{u} ( i )}} {H ( {t}_{u} ( i ) \vert {t}_{v} ( i ) , {α}_{v , k} )}^{{w}_{i , u , v} {z}_{u , k}} \cdot {S ( {t}_{u} ( i ) \vert {t}_{v} ( i ) , {α}_{v , k} )}^{{z}_{u , k}}$$

The first line of the above equations modes the fact that given the current community assignment, there is a need to maximize the likelihood: (u,i) \not \in D “survived” to the infection process. That is, even though user u did not initially adopt item i, the user was within an expected time frame (e.g., [0,T]) and survived for the ultimate adoption. The survival function is referenced by equation “S” above. The second and third line of the above equation model the fact that if: (u,i) \in D, then there must exist an influencing user (e.g., user v) which is compatible with the time at which user u adopted item i. “W” is a matrix where the C-Rate model expresses the latent influencer: w_{i,u,v,k}=1 if user v is believed to have triggered the adoption of item i by user u within the community k.

In order to determine W and Z, C-Rate implements the EM algorithm discussed above in order to specify the following objective function:

$${\sum }_{u , k} {γ}_{u , k} log {π}_{k} - {\sum }_{〈 u , i 〉 ∉ 𝔻} {\sum }_{k} {\sum }_{v ∈ {C}_{i}} {γ}_{u , k} {Δ}_{v} {α}_{v , k} + {\sum }_{〈 u , i 〉 ∈ 𝔻} {\sum }_{k} {\sum }_{v ∈ {C}_{i , {t}_{u} ( i )}} {η}_{i , u , v , k} {γ}_{u , k} log {α}_{v , k} - {\sum }_{〈 u , i 〉 ∈ 𝔻} {\sum }_{k} {\sum }_{v ∈ {C}_{i , {t}_{u} ( i )}} {γ}_{u , k} {Δ}_{u , v} {α}_{v , k} ,$$

The two steps of the EM algorithm are given by the following equations:

$$P ( u \vert {Θ}_{k} ) = {\prod }_{i : u ∉ {C}_{i}} {\prod }_{v ∈ {C}_{i}} S ( T \vert {t}_{v} ( i ) , {α}_{v , k} ) \cdot {\prod }_{i : u ∈ {C}_{i}} {\prod }_{v ∈ {C}_{i , {t}_{u} ( i )}} S ( {t}_{u} ( i ) \vert {t}_{v} ( i ) , {α}_{v , k} )$$

$$Gamma\_ \{ u , k \} = {\sum }_{v ∈ {C}_{i , {t}_{u} ( i )}} H ( {t}_{u} ( i ) \vert {t}_{v} ( i ) , {α}_{v , k} ) ;$$

$$and$$

$${η}_{u , i , v , k} = \frac{H ( {t}_{u} ( i ) \vert {t}_{v} ( i ) , {α}_{v , k} )}{{\sum }_{{v}^{′} ∈ {C}_{i , {t}_{u} ( i )}} H ( {t}_{u} ( i ) \vert {t}_{v} ( i ) , {α}_{{v}^{′} , k} )} .$$

Finally, optimizing Q(θ; θ^{(t-1)}) yields

$${α}_{k , v} = \frac{{\sum }_{{〈 u , i 〉 ∈ 𝔻}_{v ∈ {C}_{i , {t}_{u} ( i )}}} {η}_{i , u , v , k} {γ}_{u , k}}{{\sum }_{{〈 u , i 〉 ∉ 𝔻}_{v ∈ {C}_{i}}} {γ}_{u , k} {Δ}_{v} + {\sum }_{{〈 u , i 〉 ∈ 𝔻}_{v ∈ {C}_{i , {t}_{u} ( i )}}} {γ}_{u , k} {Δ}_{u , v}} ,$$

Thus, through applications of the C-Rate model and implementations of the above equations, Process 400 can determine communities and community membership of users within the unobserved social network. Step 406. Additionally, the C-Rate model also effectuates the determination of each user's influence within each community over other users. Step 406. By fitting the model parameters of the C-Rate model to the user activity log D, the disclosed systems and methods can determine user community membership and associated influence levels though modeled temporal dynamics of user activity, as discussed above.

Therefore, through the application of diffusion models C-IC and C-Rate modeling, community detection is achieved in a network-oblivious setting. The difference between C-IC modeling and C-Rate modeling is the manner in which each models the contagion: C-IC is a discrete-time model, whereas C-Rate models a continuous-time diffusion scenario. Both modeling techniques are robust and effective and can be profitably employed to discover communities and regions of influence in situations where social connections are not visible. As such, through the implementation of models C-IC and/or C-Rate, Step 406 can fit parameters of each diffusion model to the user activity log D associated with an unobserved social network in order to determine 1) communities in the unobserved social network, 2) user membership in such communities, and 3) each user's level of influence within each community for which they belong.

In Step 408, a determination is made regarding a “key” member of each identified community. The identification of “key” users within each community (i.e., leaders who are most likely to influence the rest of the community to adopt a certain item) is based upon each determined community and the membership in each community. For example, community K is determined having membership of users A, B, C and D. From the analysis of Step 406, user A is identified as having the most influential activity respective users B, C and D. Therefore, user A is identified as being the “key” user in community K. Therefore, for example, “key” user A would be the ideal user to target in a viral marketing campaign. For example, an advertisement or promotion of an item could be targeted to user A for positioning on user A's social page. The advertisement, in some embodiments, may be based upon the item that was adopted by the users in the community. Therefore, for example, if users A, B and C of community k have adopted item i, which is a Groupon® for golfing, advertisements may be displayed on the social page of user A (and/or users B and C, in some embodiments) related to golfing, and/or other Groupon® promotions. Additionally, after identifying user A as the “key” member of the community, ads and other promotions may be based solely upon user A's activity, irrespective of whether user B, C or D have adopted such items, as user A has been identified as carrying influence of other members of the community. Therefore, because user A is the most influential user in community K, there is the expectation, and greater chance of the other users in the community acknowledging and/or utilizing such advertisement or promotion.

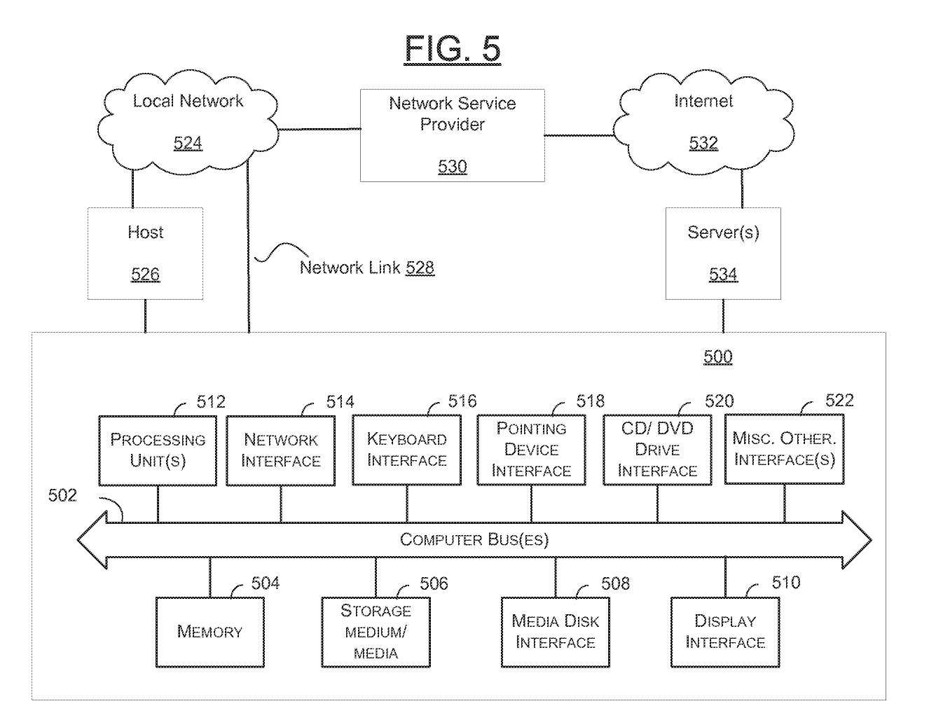

As shown in FIG. 5, internal architecture 500 includes one or more processing units, processors, or processing cores, (also referred to herein as CPUs) 512, which interface with at least one computer bus 502. Also interfacing with computer bus 502 are computer-readable medium, or media, 506, network interface 514, memory 504, e.g., random access memory (RAM), run-time transient memory, read only memory (ROM), media disk drive interface 520 as an interface for a drive that can read and/or write to media including removable media such as floppy, CD-ROM, DVD, media, display interface 510 as interface for a monitor or other display device, keyboard interface 516 as interface for a keyboard, pointing device interface 518 as an interface for a mouse or other pointing device, and miscellaneous other interfaces not shown individually, such as parallel and serial port interfaces and a universal serial bus (USB) interface.

Memory 504 interfaces with computer bus 502 so as to provide information stored in memory 504 to CPU 512 during execution of software programs such as an operating system, application programs, device drivers, and software modules that comprise program code, and/or computer executable process steps, incorporating functionality described herein, e.g., one or more of process flows described herein. CPU 512 first loads computer executable process steps from storage, e.g., memory 504, computer readable storage medium/media 506, removable media drive, and/or other storage device. CPU 512 can then execute the stored process steps in order to execute the loaded computer-executable process steps. Stored data, e.g., data stored by a storage device, can be accessed by CPU 512 during the execution of computer-executable process steps.

Persistent storage, e.g., medium/media 506, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 528 typically provides information communication using transmission media through one or more networks to other devices that use or process the information. For example, network link 528 may provide a connection through local network 524 to a host computer 526 or to equipment operated by a Network or Internet Service Provider (ISP) 530. ISP equipment in turn provides data communication services through the public, worldwide packet-switching communication network of networks now commonly referred to as the Internet 532.

A computer called a server host 534 connected to the Internet 532 hosts a process that provides a service in response to information received over the Internet 532. For example, server host 534 hosts a process that provides information representing video data for presentation at display 510. It is contemplated that the components of system 500 can be deployed in various configurations within other computer systems, e.g., host and server.

At least some embodiments of the present disclosure are related to the use of computer system 500 for implementing some or all of the techniques described herein. According to one embodiment, those techniques are performed by computer system 500 in response to processing unit 512 executing one or more sequences of one or more processor instructions contained in memory 504. Such instructions, also called computer instructions, software and program code, may be read into memory 504 from another computer-readable medium 506 such as storage device or network link. Execution of the sequences of instructions contained in memory 504 causes processing unit 512 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through communications interface, carry information to and from computer system 500. Computer system 500 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 502 as it is received, or may be stored in memory 504 or in storage device or other non-volatile storage for later execution, or both.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, at a computing device, a log of user activity for a plurality of users, said activity log comprising activity information for each of said plurality of users;
determining, via the computing device, an unobserved social network of users, said determination comprising parsing the log of user activity and identifying users from said plurality that share connections with each other based on said activity information in the log;
determining, via the computing device, a community within the unobserved social network of users, said community associated with a common activity identifiable from said log of user activity;
determining, via the computing device, user membership within said community based on said activity information in said log of user activity, said user membership comprising a cluster of users sharing said common activity;
determining, via the computing device, a level of influence for each user in said cluster, said level of influence comprising a measure of likelihood that each user's activity has an influence on another user's activity in said cluster, said measure of likelihood based on said activity information for each user in said cluster; and
determining, via the computing device, a user from said cluster having a highest level of influence.

2. The method of claim 1, wherein said determination of the unobserved social network is based upon an application of an Expectation Maximization (EM) algorithm on said log of user activity.

3. The method of claim 1, further comprising:
fitting model parameters of a diffusion model to portions of the log of user activity that are associated with the users in the unobserved social network, said model parameter fitting effectuating the modeling of social contagion of said plurality of users.

4. The method of claim 3, wherein said diffusion model is based upon a probability that each user in the unobserved social network performed said common activity, where said performance of said common activity occurs respective discrete time.

5. The method of claim 4, wherein said diffusion model applies formula:
$$P ( 𝔻 \vert Z , Θ ) = {\prod }_{i , u , k} {[ 1 - {\prod }_{v ∈ {F}_{i , u}^{+}} ( 1 - {p}_{v}^{k} ) ]}^{{z}_{u , k}} \cdot {[ {\prod }_{v ∈ {F}_{i , u}^{-}} ( 1 - {p}_{v}^{k} ) ]}^{{z}_{u , k}} ,$$
wherein u denotes user u, a member of said community;
wherein v denotes user v, a member of said community;
wherein i denotes said common activity;
wherein p_{u,v} is a level of influence of user u on user v;
wherein k denotes said community;
wherein p̂k_v is a measure of strength of user v's influence on members of community k; and
wherein Z is a matrix encoding said user membership in said community k.

6. The method of claim 5, further comprising:
estimating said user membership in said community k, said estimation based upon an Expectation Maximization (EM) algorithm on said log of user activity.

7. The method of claim 6, wherein said estimation further comprises applying formula:
$${\sum }_{u} {\sum }_{k} {γ}_{u , k} ( log {π}_{k} + {\sum }_{i} {\sum }_{v ∈ {F}_{i , u}^{-}} log ( 1 - {p}_{v}^{k} ) + {\sum }_{i} {\sum }_{v ∈ {F}_{i , u}^{+}} {η}_{i , u , v , k} log {p}_{v}^{k} + ( 1 - {η}_{i , u , v , k} ) log ( 1 - {p}_{k}^{k} ) ) ,$$
wherein gamma_{u,k}=P(z_{u,k}=1; and
wherein \eta {i,u,v,k}denotes a probability that when user u is assigned to said community k, user v is responsible for triggering said user u's engagement in said common activity.

8. The method of claim 7, further comprising optimizing said estimation formula b alternating
$$gamma\_ \{ u , k \} = P ( u \vert {Θ}_{k} ) = {\prod }_{.} {{P}_{+} ( i \vert u , {Θ}_{k} )}^{{Y}_{i , u}} \cdot {P}_{-} ( i \vert u , {Θ}_{k} ) , , \\ and$$
$$\begin{matrix}{η}_{i , u , v , k} = P ( {w}_{i , u , v} = 1 \vert u , i , {z}_{u , k} = 1 , {θ}^{( t - 1 )} ) \\ = \frac{{p}_{v}^{k}}{1 - {\prod }_{w ∈ {F}_{i , u}^{+}} ( 1 - {p}_{w}^{k} )} .\end{matrix}$$
$${p}_{v}^{k} = \frac{{\sum }_{{〈 u , i 〉}_{v ∈ {F}_{i , u}^{+}}} {γ}_{u , k} \cdot {η}_{i , u , v , k}}{{S}_{v , k}^{+} + {S}_{v , k}^{-}} , \\ with$$
$${S}_{v , k}^{+} = {\sum }_{{〈 u , i 〉}_{v ∈ {F}_{i , u}^{+}}} {γ}_{u , k}$$
$$and$$
$${S}_{v , k}^{-} = {\sum }_{{〈 u , i 〉}_{v ∈ {F}_{i , u}^{-}}} {γ}_{u , k} ..$$

9. The method of claim 3, wherein said diffusion model is based upon a time when said common activity occurs for each user in said community.

10. The method of claim 9, wherein said diffusion model applies formula:
$$P ( 𝔻 , W \vert Z , Θ ) = {\prod }_{〈 u , i 〉 ∉ 𝔻} {\prod }_{k} {\prod }_{v ∈ {C}_{i}} {S ( T \vert {t}_{v} ( i ) , {α}_{v , k} )}^{{z}_{u , k}} \cdot {\prod }_{〈 u , i 〉 ∈ 𝔻} {\prod }_{k} {\prod }_{v ∈ {C}_{i , {t}_{u} ( i )}} {H ( {t}_{u} ( i ) \vert {t}_{v} ( i ) , {α}_{v , k} )}^{{w}_{i , u , v} {z}_{u , k}} \cdot {S ( {t}_{u} ( i ) \vert {t}_{v} ( i ) , {α}_{v , k} )}^{{z}_{u , k}} ,$$
wherein u denotes user u, a member of said community;
wherein v denotes user v, a member of said community;
wherein i denotes said common activity;
wherein k denotes said community;
wherein α_{v,k} denotes a transmission rate of said common activity (i) within said community (k), said transmission rate based in part upon a time delay user u performs said common activity and user v performs said activity, wherein a high value of said transmission rate reflects a high value of said level of influence;
wherein Z is a matrix encoding said user membership in said community k; and
wherein W is a matrix expressing a latent influencer: w_{i,u,v,k}=1, said {i,u,v,k} denoting a probability that user v triggered user u's engagement in said common activity.

11. The method of claim 10, further comprising:
estimating said user membership in said community k, said estimation based upon an Expectation Maximization (EM) algorithm on said log of user activity.

12. The method of claim 11, wherein said estimation further comprises applying formula:
$${\sum }_{u , k} {γ}_{u , k} log {π}_{k} - {\sum }_{〈 u , i 〉 ∉ 𝔻} {\sum }_{k} {\sum }_{v ∈ {C}_{i}} {γ}_{u , k} {Δ}_{v} {α}_{v , k} + {\sum }_{〈 u , i 〉 ∈ 𝔻} {\sum }_{k} {\sum }_{v ∈ {C}_{i , {t}_{u} ( i )}} {η}_{i , u , v , k} {γ}_{u , k} log {α}_{v , k} - {\sum }_{〈 u , i 〉 ∈ 𝔻} {\sum }_{k} {\sum }_{v ∈ {C}_{i , {t}_{u} ( i )}} {γ}_{u , k} {Δ}_{u , v} {α}_{v , k} , , \\ P ( u \vert {Θ}_{k} ) = {\prod }_{i : u ∉ {C}_{i}} {\prod }_{v ∈ {C}_{i}} S ( T \vert {t}_{v} ( i ) , {α}_{v , k} ) \cdot {\prod }_{i : u ∈ {C}_{i}} {\prod }_{v ∈ {C}_{i , {t}_{u} ( i )}} S ( {t}_{u} ( i ) \vert {t}_{v} ( i ) , {α}_{v , k} )$$
$$wherein$$
$$gamma\_ \{ u , k \} = {\sum }_{v ∈ {C}_{i , {t}_{u} ( i )}} H ( {t}_{u} ( i ) \vert {t}_{v} ( i ) , {α}_{v , k} ) ;$$
$$and$$
$${η}_{u , i , v , k} = \frac{H ( {t}_{u} ( i ) \vert {t}_{v} ( i ) , {α}_{v , k} )}{{\sum }_{{v}^{′} ∈ {C}_{i , {t}_{u} ( i )}} H ( {t}_{u} ( i ) \vert {t}_{v} ( i ) , {α}_{{v}^{′} , k} )} . \\ wherein .$$

13. The method of claim 12, further comprising optimizing said estimation formula which yields:
$${α}_{k , v} = \frac{{\sum }_{{〈 u , i 〉 ∈ 𝔻}_{v ∈ {C}_{i , {t}_{u} ( i )}}} {η}_{i , u , v , k} {γ}_{u , k}}{{\sum }_{{〈 u , i 〉 ∉ 𝔻}_{v ∈ {C}_{i}}} {γ}_{u , k} {Δ}_{v} + {\sum }_{{〈 u , i 〉 ∈ 𝔻}_{v ∈ {C}_{i , {t}_{u} ( i )}}} {γ}_{u , k} {Δ}_{u , v}} , .$$

14. The method of claim 1, wherein the activity information comprised within said log of user activity comprises a tuple of information corresponding to an identifier of each user, an item each user has adopted and a time each user adopted said item, wherein said item is associated with said common activity.

15. The method of claim 1, further comprising:
serving an advertisement to said determined user of said cluster having the highest level of influence.

16. A non-transitory computer-readable storage medium tangibly encoded with computer-executable instructions, that when executed by a processor associated with a computing device, performs a method comprising:
receiving a log of user activity for a plurality of users, said activity log comprising activity information for each of said plurality of users;
determining an unobserved social network of users, said determination comprising parsing the log of user activity and identifying users from said plurality that share connections with each other based on said activity information in the log;
determining a community within the unobserved social network of users, said community associated with a common activity identifiable from said log of user activity;
determining user membership within said community based on said activity information in said log of user activity, said user membership comprising a cluster of users sharing said common activity;
determining a level of influence for each user in said cluster, said level of influence comprising a measure of likelihood that each user's activity has an influence on another user's activity in said cluster, said measure of likelihood based on said activity information for each user in said cluster; and
determining a user from said cluster having a highest level of influence.

17. The non-transitory computer-readable storage medium of claim 16, wherein said determination of the unobserved social network is based upon an application of an Expectation Maximization (EM) algorithm on said log of user activity.

18. The non-transitory computer-readable storage medium of claim 16, further comprising:
fitting model parameters of a diffusion model to portions of the log of user activity that are associated with the users in the unobserved social network, said model parameter fitting effectuating the modeling of social contagion of said plurality of users, wherein said diffusion model is based upon a probability that each user in the unobserved social network performed said common activity, where said performance of said common activity occurs respective discrete time.

19. A system comprising:
at least one computing device comprising:
memory storing computer-executable instructions; and
one or more processors for executing said computer-executable instructions, comprising:
receiving a log of user activity for a plurality of users, said activity log comprising activity information for each of said plurality of users;
determining an unobserved social network of users, said determination comprising parsing the log of user activity and identifying users from said plurality that share connections with each other based on said activity information in the log;
determining a community within the unobserved social network of users, said community associated with a common activity identifiable from said log of user activity;
determining user membership within said community based on said activity information in said log of user activity, said user membership comprising a cluster of users sharing said common activity;
determining a level of influence for each user in said cluster, said level of influence comprising a measure of likelihood that each user's activity has an influence on another user's activity in said cluster, said measure of likelihood based on said activity information for each user in said cluster; and
determining a user from said cluster having a highest level of influence.

20. The system of claim 19, further comprising:
fitting model parameters of a diffusion model to portions of the log of user activity that are associated with the users in the unobserved social network, said model parameter fitting effectuating the modeling of social contagion of said plurality of users, wherein said diffusion model is based upon a probability that each user in the unobserved social network performed said common activity, where said performance of said common activity occurs respective discrete time.
